(19) United States
(12) Patent Application Publication
(10) Pub. No.: US 2007/0078914 A1
(43) Pub. Date: Apr. 5, 2007

(54) Method, apparatus and program storage device for providing a centralized policy based preallocation in a distributed file system

(75) Inventors: Stephen F. Correl, Portland, OR (US); Frank Stewart Fitz, Beaverton, OR (US); James John Seeger JR., Portland, OR (US)

Correspondence Address: DAVID W. LYNCH;CHAMBLISS, BAHNER & STOPHEL, 1000 TALLAN SQUARE-S, TWO UNION SQUARE, CHATTANOOGA, TN, 37402, US

(73) Assignee: International Business Machines Corporation

(21) Appl. No.: 11/241,415

(22) Filed: Sep. 30, 2005

(51) Int. Cl. G06F 17/30

(52) U.S. Cl. 707/205

(57) ABSTRACT

A method, apparatus and program storage device for providing a centralized policy based preallocation in a distributed file system. Policy rules are used to provide for the specification of a preallocation and an extend size for files in a computer system. An administrator specifies the pre-allocation and extend sizes for a set of files as defined in the set of policy rules. Policy rules used in this manner can take into account the unique situation in which a file is being created or extended.

### BACKGROUND OF THE INVENTION

1. Field of the Invention

This invention relates in general to file systems for computer systems, and more particularly to a method, apparatus and program storage device for providing a centralized policy based preallocation in a distributed file system.

2. Description of Related Art

A computer operating system may represent a collection of computer programs or routines which control the execution of application programs and that may provide services such as resource allocation, scheduling, input/output control, and data management. Most operating systems store logical units of data in files, and files are typically grouped in logical units of folders. Computer systems often process large quantities of information, including application data and executable code configured to process such data. In numerous embodiments, computer systems provide various types of mass storage devices configured to store data, such as magnetic and optical disk drives, tape drives, etc.

To provide a regular and systematic interface through which to access their stored data, such storage devices are frequently organized into hierarchies of files by software such as an operating system. Often a file defines a minimum level of data granularity that a user can manipulate within a storage device, although various applications and operating system processes may operate on data within a file at a lower level of granularity than the entire file.

Most file systems have not only files, but also data about the files in the file system. This data typically includes time of creation, time of last access, time of last write, time of last change, file characteristics (e.g., read-only, system file, hidden file, archive file, control file), and allocation size.

Storage area networks (SANs) enable the sharing of storage resources across one or more enterprises. But for many companies, information resources are spread over a variety of storage and server environments, often using products from different vendors. The result can be a multitude of file systems that need to be managed individually, which can increase complexity and costs, limit growth and increase operational risk. Many companies require a variety of skilled resources and find it difficult to implement consistent policies for file and database management. File and data administration tasks often impact application availability, leading to poor utilization of storage resources, high costs and reduced business efficiency.

Many applications have a preferred file size or allocation pattern for specific classes of files. In the relational database world, data files often have a uniform file size, for example the initial size may be 2 GB, and then the file size grows in some well-defined increment beyond that. During the file's initialization, the application will reserve the required amount of file system disk space by extending the file at some constant size. Many digital media applications write files of many megabytes in size from beginning to the end in one continuous sequence of writes. These examples require many calls into the file system.

Several file systems provide the capability for an application to call a special API to indicate a recently created file should be reserved a specific amount of disk space. Generally a second API is available that allows the application to extend a file by a specified number of blocks. However, this requires changes to an application that would like to take advantage of such a feature. For example, support to make API calls and/or additional commands for extending a file size must be integrated into an application to be able to utilize such features. Furthermore, once the allocation size is compiled into an application it is either static and can't be changed or requires tuning for each instance of that application.

Most file systems allow configuration of allocation behavior at the level of whole file systems. In other words, each file written within a single traditional file system instance will have the same allocation behavior. This limitation can force users to put files into different file systems as dictated by the desired allocation behavior, which greatly complicates administration.

Some file systems allow configuration of allocation behavior according to the physical or virtual storage device used to store the file. In other words, each file written to a given storage device will have the same allocation behavior. This limitation can force users to put files onto different storage devices as dictated by the desired allocation behavior, which greatly complicates administration.

It can be seen that there is a need for a method, apparatus and program storage device for providing a centralized policy based preallocation in a distributed file system.

### SUMMARY OF THE INVENTION

To overcome the limitations in the prior art described above, and to overcome other limitations that will become apparent upon reading and understanding the present specification, the present invention discloses a method, apparatus and program storage device for providing a centralized policy based preallocation in a distributed file system.

The present invention solves the above-described problems by providing policy rules that provide for the specification of a preallocation and an extend size for files in a computer system. An administrator specifies various pre-allocation and extends sizes for sets of files as defined in the set of policy rules. Policy rules used in this manner can take into account the unique situation in which a file is being created or extended.

A policy database for providing policy-based preallocation in a file system in accordance with the principles of the present invention includes at least one rule set comprising at least one rule for specifying a preallocation size for a file being created.

In another embodiment of the present invention, a method for controlling files in a file system is provided. The method includes detecting a file event, determining whether file meets a predetermined criterion and setting a file parameter according to a policy rule when the file meets a predetermined criterion.

In another embodiment of the present invention, a program storage device that includes program instructions executable by a processing device to perform operations for controlling files in a file system is provided. The operations includes detecting a file event, determining whether file meets a predetermined criterion and setting a file parameter according to a policy rule when the file meets a predetermined criterion.

In another embodiment of the present invention, a computer is provided. The computer includes memory for storing data and program instructions and a processor, coupled to the memory, the processor being configured to detect a file event, determine whether file meets a predetermined criterion and set a file parameter according to a policy rule when the file meets a predetermined criterion.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 schematically illustrates a hardware environment of an embodiment of the present invention;

FIG. 2 illustrates a SAN file system architecture according to an embodiment of the present invention;

FIG. 3 illustrates a SAN according to an embodiment of the present invention;

FIG. 4 illustrates policy rules for a centralized policy-based preallocation in a distributed file system according to an embodiment of the present invention;

FIG. 5 is a flow chart for creating a file and an associated file size allocation according to an embodiment of the present invention; and

FIG. 6 is a flow chart for extending a file size according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for providing a centralized policy based preallocation in a distributed file system. Policy rules are used to specify a pre-allocation and an extend size for files in a computer system. An administrator specifies various pre-allocation and extend sizes for sets of files as defined in the set of policy rules. Policy rules used in this manner can take into account the unique situation in which a file is being created or extended.

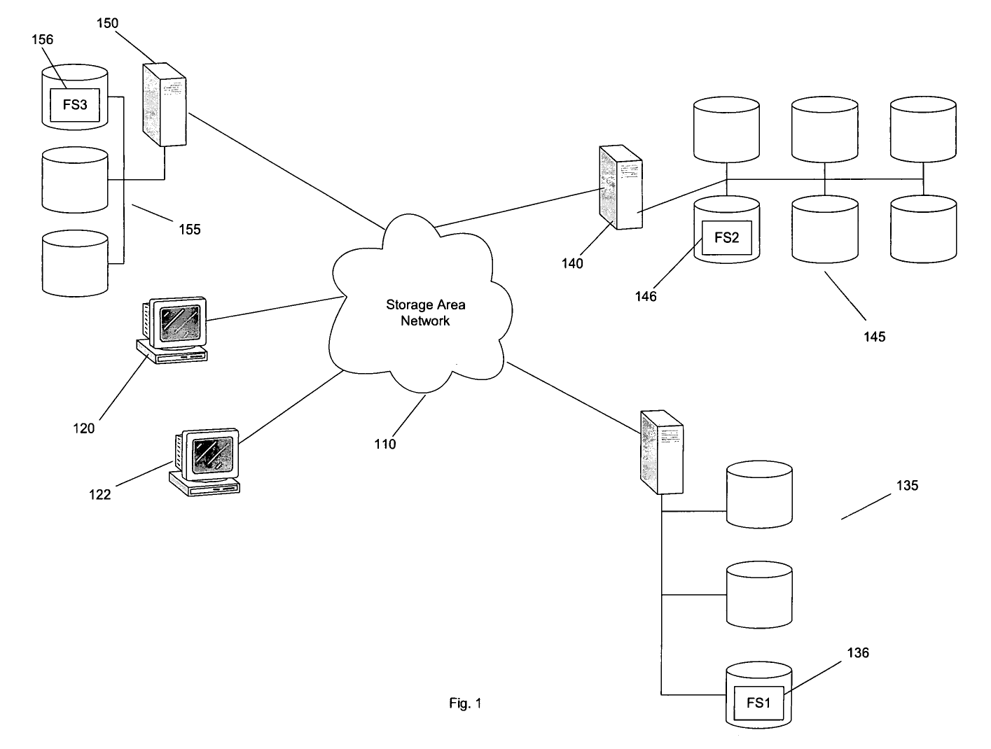

FIG. 1 schematically illustrates a hardware environment of a system 100 representing one embodiment of the present invention. A network 110 provides an electronic communications medium that connects a user at a client computer 120 to server computers. For example, client computers 120, 122 may be coupled to first and second server computers 130, 140. The first and second server computers 130, 140 respectively may use first and second operating systems having respective file systems 136, 146 on first and second storage arrays 135, 145. The first and second operating systems can be different operating systems or can be the same operating system.

The client computers 120, 122 are also connected to a third server computer 150. The third server computer 150 may use a third operating system having an associated file system 156 for use with third storage array 155. Each of the first, second, and third storage arrays 135, 145, 155 may include a plurality of storage devices or may be a single storage device. Storage device as used herein may encompass hard disk drives, tape drives, solid-state memory devices, or other types of storage devices. The third operating system may be different from the first and second operating systems or may be the same operating system.

The client computer 120 may be a personal computer, a workstation, a handheld computer, etc. The server computers 130, 140, 150 may be personal computers, workstations, minicomputers, or mainframes. The client computer 120 and the server computers 130, 140, 150 may be bi-directionally coupled to the communications networks 110 over communications lines, via wireless systems, or any combination thereof. For example, client computers 120, 122 and the server computers 130, 140, 150 may be coupled to one another by various private networks, public networks or any combination thereof, including local-area networks (LANs), wide-area networks (WANs), or the Internet. Those skilled in the art will recognize many modifications may be made to this configuration without departing from the scope of the present invention.

A virtual storage volume can be created in accordance with the present invention, for example, by a user at client computers 120, 122 creating a file in the user's home directory, or loading data from a tape or other storage device to a file in the user's home directory. Conventionally, files located in the user's home directory are conventionally subject to a number of constraints, including, but not limited to, the maximum file size, the maximum file-system size, and the size of the user's local hard disk drive.

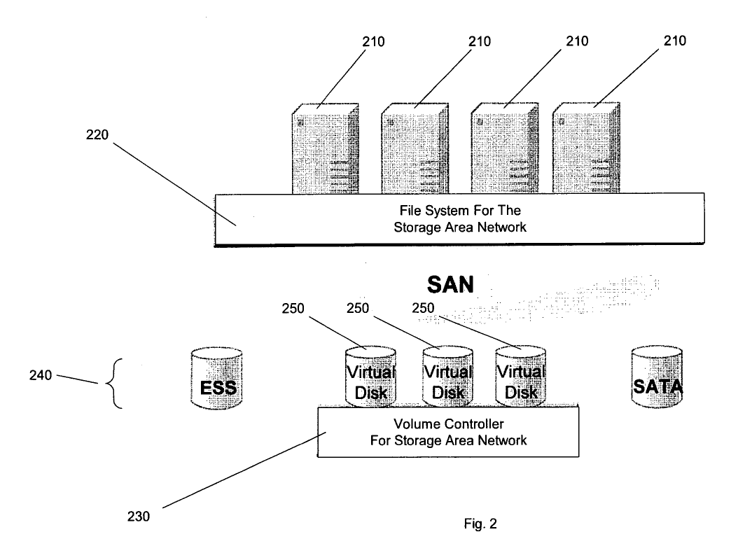

FIG. 2 illustrates a file system for the storage area network architecture 200 according to an embodiment of the present invention. The SAN file system architecture 200 makes it possible to bring the benefits of the existing mainframe System-Managed Storage (SMS) to the SAN environment. In FIG. 2, servers/clients 210 use the SAN file system 220 to provide a single, centralized point of control to better manage files and data. The file system for the storage area network 220 is platform independent. A volume controller for a storage area network 230 abstracts the physical disks 240 into one or more virtual disks 250. In other words, storage space that may be regarded as addressable main storage of real addresses are mapped into virtual addresses. The file system for the storage area network 220 provides policy-based allocation, volume management, and file management. This infrastructure for such centralized, automated management has been lacking in the open systems world of Linux, Windows and UNIX because on conventional systems storage management is platform dependent. However, as mentioned above, the file system for the storage area network 220 provides a single, centralized point of control to better manage files and data, and is platform independent. Centralized file and data management dramatically simplifies storage administration and lowers the total cost of ownership.

By managing file details (via the meta-data controller) on the storage network instead of in individual servers, the file system for the storage area network 220 of the present invention moves the file system intelligence into the storage network where it can be available to all application servers. Doing so provides a single namespace and a single point of management. This eliminates the need to manage files on a server-by-server basis. The file system for the storage area network 220 automates routine and error-prone tasks, such as file placement, and handles out of space conditions. The file system for the storage area network 220 also allows true heterogeneous file sharing, wherein the reader and writer of the exact same data can run different operating systems.

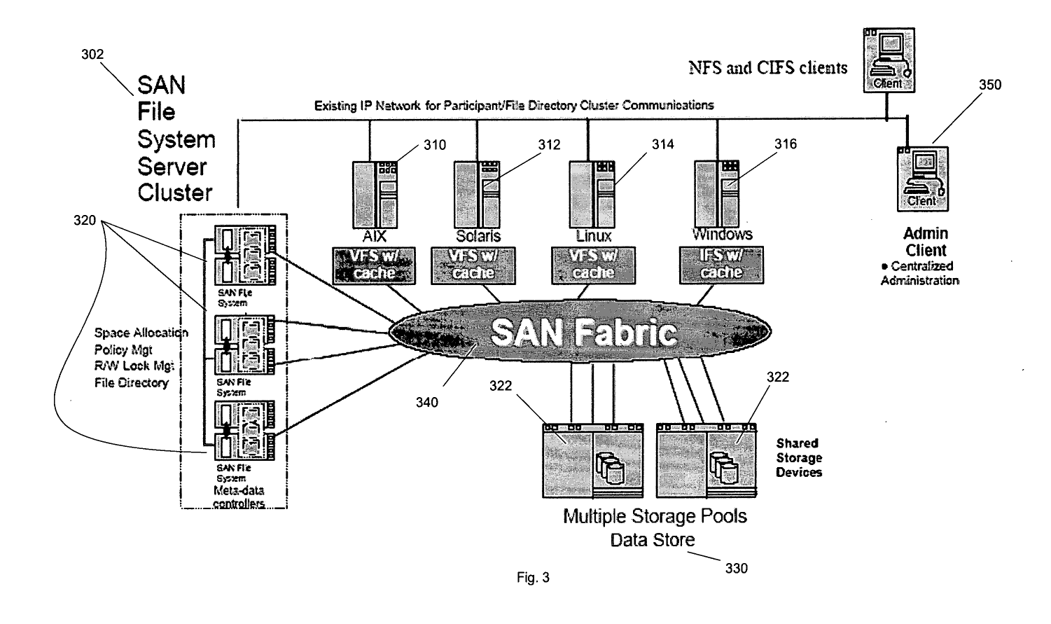

FIG. 3 illustrates a SAN 300 according to an embodiment of the present invention. In FIG. 3, application servers 310-316, which request a file, obtain information about the file (the meta-data) from the meta-data controllers 320 of the SAN file system 302 that manages file locks and all other file information. The SAN file system 302 then provides that information to the application servers 310-316, which then accesses the blocks comprising that file at the storage pools of the data store 330 directly through the SAN fabric 340. By caching the meta-data in a client and providing direct access from the application servers 310-316 to the underlying storage devices 322 in data store 330, the SAN file system 302 provides local file system performance over the SAN 300.

The SAN file system 302 consists of a small module of enablement code that runs on application servers 310-316 and meta-data controller 320. The features of the SAN file system 302 work together to provide a variety of benefits to customers. One of the major benefits is a single image or global namespace. This function shields the end user from storage network complexity, and dramatically reduces administrative workload via an administration client 350. Since the SAN file system 302 is designed to be implemented on a variety of operating systems, e.g., Windows to various flavors of Linux and UNIX, the SAN file system 302 will allow all of these operating systems to share files. For example, a file created in Windows will be as accessible from a Windows client 316 as it is from Solaris 312, AIX 310, or any other supported platform, and vice versa. However, an application is still required to be able to read that file, no matter how accessible it is.

Since the SAN file system 302 will have a complete understanding of all files on the SAN 300, including the essential meta-data related to each file to make important decisions, the SAN file system 302 is a logical point to manage the storage on the network through policy-based controls. For example, the SAN file system 302 can decide where to place each file based on user-defined criteria, such as file type, using policy-based automation. Setting these policies relieves the storage administrator of the burden of repetitive tasks, and forms the basis of automation.

The SAN file system 302 provides the ability to group storage devices according to their characteristics, such as latency and throughput. These groupings, called storage pools 330, allow administrators to manage data according to predetermined characteristics. Because the meta-data for the SAN file system 302 is separate from the application data, files can be manipulated while remaining active. When files are removed from service, the SAN file system 302 will automatically reallocate the space without disruption. If a LUN is removed from the control of the SAN file system 302, the data on that LUN is automatically moved. Accordingly, the SAN file system 302 is designed to provide policy-based storage automation capabilities for provisioning and data placement, non-disruptive data migration, and a single point of management for files on a storage network.

While the meta-data controller 320 is shown in FIG. 3 as a separate entity, embodiments of the present invention are not meant to be limited to the use of a meta-data controller 320 that is a separate entity. Rather, and meta-data controller 320 may reside on any client 310-316 in the network or even within a storage servers 322.

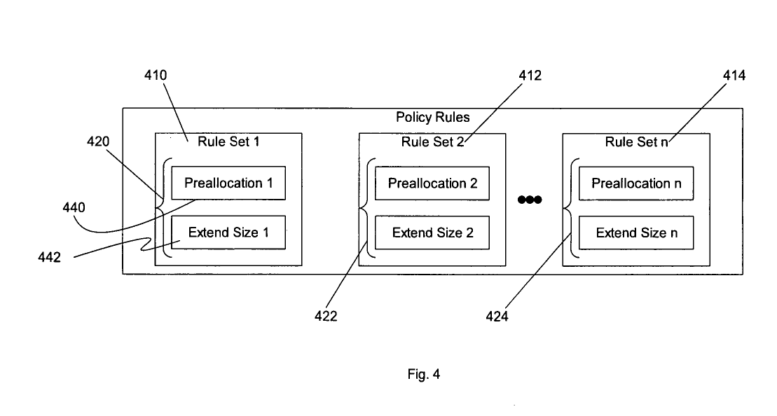

FIG. 4 illustrates policy rules 400 for a centralized policy-based preallocation in a distributed file system according to an embodiment of the present invention. In FIG. 4, the policy rules 400 include one example of a set of rules 410, 412, 414. Although 3 sets of policy rules are shown in FIG. 4, it must be noted that more or less than three sets of policy rules may be used by the present invention. Each of the rules sets 410, 412, 414 in the example includes a set of files 420, 422, 424. The set of files 420, 422, 424 for implementing the policy-based preallocation in a distributed file system include a specification for a preallocation 440 and a file for specifying an extend size 442. An administrator specifies the pre-allocation 440 and extend size 442 for a set of files 420 as defined in the set of policy rules 410. Policy rules 400 used in this manner can take into account the unique situation in which a file is being created or extended. This approach requires no application changes to take advantage of more optimal space allocations. Each rule 410, 412, 414 is uniformly applicable across the entire distributed file system or optionally to a specific portion of the file system, e.g., a file set in the SAN file system, but it only takes effect when a file creation or allocation matches the rule pre-condition. The policy rules 410, 412, 414 can be modified and activated an unlimited number of times to address new applications or new storage in a customer's environment or as allocation tuning is required. Additionally, an administrator may decide to tune allocation patterns to avoid excessive file system fragmentation by using a well-defined set of pre-allocation rules.

An administrator may direct which files got stored on which class of storage based on a file's file name, file set, owner, or timestamp when the file was created. The policy rules 400 are specified as a set of statements. An applicability cache may be maintained to reduce the performance impact on file creation and extension in file sets that have no policy rules. A query evaluator may be utilized to evaluate matches locally on each SAN file system subordinate node.

Accordingly, the example of a set of policy rules 410, 412, 414 are expanded to include the ability to specify a pre-allocation 440 and extend size 442 for specific files. If a file matches a rule with an EXTEND qualifier, the value is stored with the object's metadata to reduce the performance impact at block allocation time. An example of a rule for a “datafile” and a rule for a “logfile” is given by:

| | | |
|---|---|---|
| RULE ‘datafile’ | SET PREALLOC 2 GB EXTEND 1 GB | WHERE |

UCASE( NAME ) LIKE ‘%.DBS”

| | | |
|---|---|---|
| RULE ‘logfile’ | SET PREALLOC 10 MB | WHERE |

UCASE( NAME ) LIKE ‘%.LOG’

Constants for the pre-allocation and extend can be dynamically updated on the fly by editing the policy set and re-activating the policy. The set of terms that can be considered in a rule's precondition is very broad. However, those skilled in the art will recognize that embodiments of the present invention could use any information available to the file system within the context when a file is created or allocation is extended.

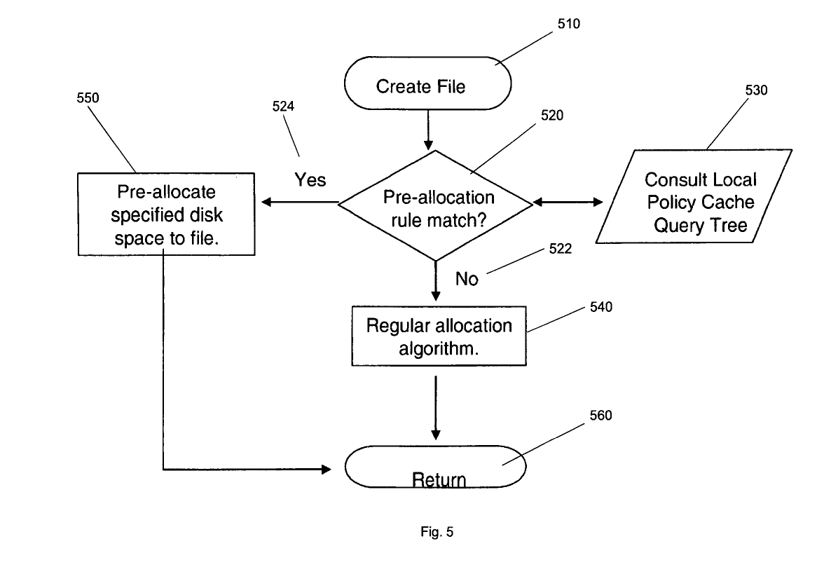

FIG. 5 is a flow chart 500 for creating a file and an associated file size allocation according to an embodiment of the present invention. In FIG. 5, a file is created 510. A decision is made whether a pre-allocation rule match occurs 520. In making the determination 520, a local policy cache query tree is consulted 530. If a preallocation match does not occur 522, a regular allocation algorithm is used 540. If a preallocation match occurs 524, a specified disk space is preallocated to the file 550. The process then recycles 560 to wait for subsequent file creation.

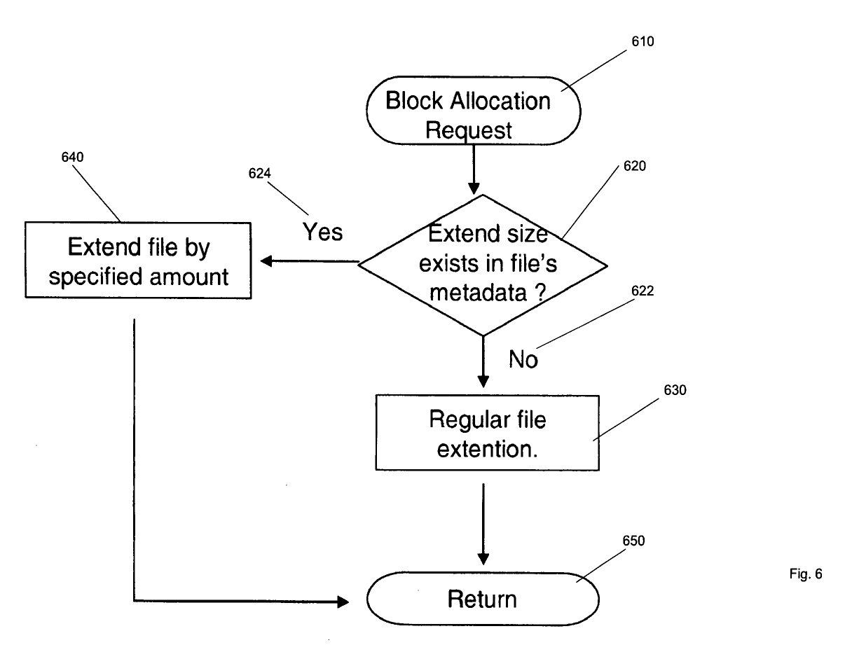

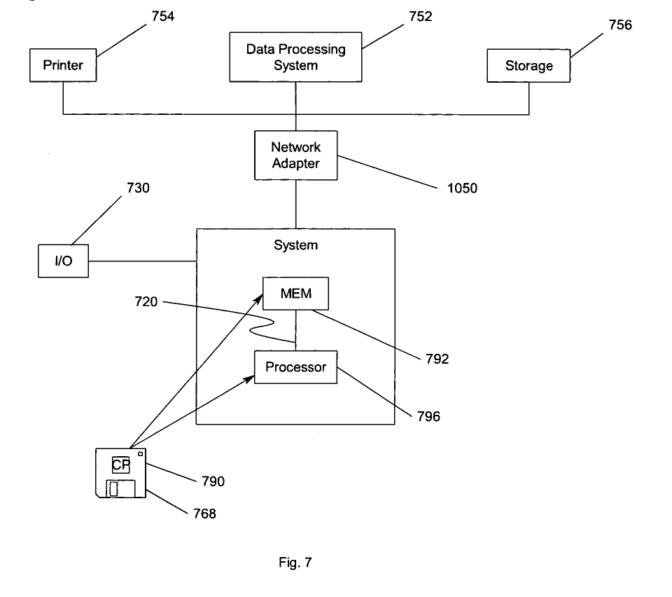

FIG. 6 is a flow chart 600 for extending a file size according to an embodiment of the present invention. In FIG. 6, a block allocation request is made 610. A determination is made whether an extend size exists in a file's metadata. If no 622, a regular file extension is implemented 630. If an extend size exists in the file's metadata 624, the file is extended by the amount specified in the file's metadata 540. The process then recycles 660 to wait for subsequent block allocation requests.

FIG. 7 illustrates a system 700 according to an embodiment of the present invention. Embodiments of the present invention may take the form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, embodiments of the present invention may take the form of a computer program product 790 accessible from a computer-usable or computer-readable medium 768 providing program code for use by or in connection with a computer or any instruction execution system.

For the purposes of this description, a computer-usable or computer readable medium 768 can be any apparatus that can contain, store, communicate, propagate, or transport the program for use by or in connection with the instruction execution system, apparatus, or device. The medium 768 may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A system suitable for storing and/or executing program code will include at least one processor 796 coupled directly or indirectly to memory elements 792 through a system bus 720. The memory elements 792 can include local memory employed during actual execution of the program code, bulk storage, and cache memories which provide temporary storage of at least some program code in order to reduce the number of times code must be retrieved from bulk storage during execution.

Input/output or I/O devices 740 (including but not limited to keyboards, displays, pointing devices, etc.) can be coupled to the system either directly to the system or through intervening I/O controllers.

Network adapters 750 may also be coupled to the system to enable the system to become coupled to other data processing systems 752, remote printers 754 or storage devices 756 through intervening private or public networks 760. Modems, cable modem and Ethernet cards are just a few of the currently available types of network adapters.

Accordingly, the computer program 790 comprise instructions which, when read and executed by the system 700 of FIG. 7, causes the system 700 to perform the steps necessary to execute the steps or elements of the present invention

The foregoing description of the embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A policy database for providing policy-based preallocation in a file system, comprising at least one rule set comprising at least one rule for specifying a preallocation size for a file being created.

2. The policy database of claim 1, wherein the at least one rule further comprises at least one rule for specifying an extend size for a file.

3. The policy database of claim 2, wherein the at least one rule for specifying an extend size for a file takes effect when a file allocation matches a predetermined criterion for the file.

4. The policy database of claim 2, wherein the at least one rule for specifying an extend size for a file comprises an extend size in metadata for the file.

5. The policy database of claim 1, wherein the rule is uniformly applicable across the entire file system.

6. The policy database of claim 1, wherein the rule is applicable to a specific portion of the file system.

7. The policy database of claim 1, wherein the at least one rule takes effect when a file creation or allocation matches the predetermined criterion for the file.

8. The policy database of claim 1, wherein the at least one rule set is configured for modification and activation to address new conditions in a user's environment.

9. A method for controlling files in a file system; comprising:
detecting a file event;
determining whether file meets a predetermined criterion; and
setting a file size parameter according to a policy rule when the file meets a predetermined criterion.

10. The method of claim 9, wherein the setting a file parameter comprises creating a file and an associated file size allocation.

11. The method of claim 10, wherein the creating a file and an associated file size allocation further comprises:
determining whether a pre-allocation rule exists in a policy rule database for the file being created; and
preallocating a disk space according to a preallocation rule provided in the policy rule database when the preallocation rule exists in the policy rule database.

12. The method of claim 11, wherein the determining whether a pre-allocation rule exists for the file being created is based on consultation of a local policy cache query tree.

13. The method of claim 9, wherein the setting a file parameter comprises extending a file size, and wherein the extending a file size further comprises:
detecting a block allocation request;
determining whether an extend size exists in metadata of the file; and
extending a space allocation to the file by an amount specified in metadata of the file when an extend size is determined to exists in metadata of the file.

14. A program storage device, comprising:
program instructions executable by a processing device to perform operations for controlling files in a file system, the operations comprising:
detecting a file event;
determining whether file meets a predetermined criterion; and
setting a file parameter according to a policy rule when the file meets a predetermined criterion.

15. The program storage device of claim 14, wherein the setting a file parameter comprises creating a file and an associated file size allocation and wherein the creating a file and an associated file size allocation further comprises:
determining whether a pre-allocation rule exists for the file being created; and
preallocating a disk space according to a preallocation rule provided in policy rule database when a preallocation rule exists in the policy rule database.

16. The program storage device of claim 15, wherein the determining whether a pre-allocation rule exists for the file being created is based on consultation of a local policy cache query tree.

17. The program storage device of claim 14, wherein the setting a file parameter comprises extending a file size and wherein the extending a file size further comprises:
detecting a block allocation request;
determining whether an extend size exists in metadata of the file; and
extending the file by an amount specified in metadata of the file when an extend size is determined to exists in metadata of the file.

18. A computer, comprising:
memory for storing data and program instructions; and
a processor, coupled to the memory, the processor being configured to detect a file event, determine whether file meets a predetermined criterion and set a file parameter according to a policy rule when the file meets a predetermined criterion.

19. The computer of claim 18, wherein the setting a file parameter comprises creating a file and an associated file size allocation, and wherein the creating a file and an associated file size allocation further comprises:
determining whether a pre-allocation rule exists for the file being created; and
preallocating a disk space according to a preallocation rule provided in policy rule database when a preallocation rule exists in the policy rule database.

20. The computer of claim 18, wherein the setting a file parameter comprises extending a file size, and wherein the extending a file size further comprises:
detecting a block allocation request;
determining whether an extend size exists in metadata of the file;
extending the file by an amount specified in metadata of the file when an extend size is determined to exists in metadata of the file.
